(19) United States
(12) Patent Application Publication
(10) Pub. No.: US 2011/0309305 A1
(43) Pub. Date: Dec. 22, 2011

(54) Flexible aqueous soluble conductive polymer compositions

(75) Inventors: Antal Istvan Jákli, Kent, OH (US); John Ernest Harden, JR., Streetsboro, OH (US); Wilder G. Iglesias Gonzalez, Kent, OH (US)

(73) Assignee: KENT STATE UNIVERSITY, Kent, OH (US)

(21) Appl. No.: 12/925,308

(22) Filed: Oct. 19, 2010

Related U.S. Application Data
(60) Provisional application No. 61/397,874, filed on Jun. 17, 2010.

(51) Int. Cl. H01B 1/12

(52) U.S. Cl. 252/500

(57) ABSTRACT

A conductive, durable, peelable and flexible polymeric composition such as a coating can be utilized as an electrode sheet or substrate for organic and polymer light emitting diodes, for organic transistors, medical electrodes, and the like. The conductive polymeric composition is a blend of a conductive polymer blend and a peelable polymer blend wherein the conductive polymer comprises a negative-charged accepting polymer and a positive-charged accepting polymer and wherein the peelable polymer blend comprises a water soluble polymer, a polyalkylene oxide, and an alkyl glycol.

### CROSS-REFERENCE

This application claims the priority filing date of U.S. Provisional Application Ser. No. 61/397,874 filed Jun. 17, 2010, herein fully incorporated by reference.

### FIELD OF THE INVENTION

The present invention relates to a mixture of two polymeric blends that yield a peelable, flexible, scratch-resistant polymer layer that has electrical conductivity equal or greater than either polymeric blend. The composition comprises an electrically conductive polymer blend and a peelable polymer blend.

### BACKGROUND OF THE INVENTION

U.S. Pat. No. 6,210,537 relates to a conductive polymer suitable for printing circuits, where flexibilizers and surfactants are added to reportedly obtain bendability up to 90 degrees. This material is non-transparent and some conductivity is lost when flexed, indicating mechanical problems. In addition the preparation process is complicated, expensive, and UV and electron beams are needed for curing.

Epoxy-like conducting pastes are set forth in U.S. Pat. No. 6,238,599 for reportedly preparing low cost and high temperature resistive lead free electrodes. These compositions have problems for use in flexible substrates, and scatter light because of the copper particles that are embedded in the mixture for higher conductivity.

Other techniques and materials, like transparent, electrically conductive polyester films disclosed in U.S. Pat. No. 7,534,487 have the inconvenience of using Indium Tin Oxide (ITO) and/or Antimony Tin Oxide (ATO), that is applied via sputtering limiting the production rate and dimensions of the item to be coated, therefore making the process relatively expensive.

### SUMMARY OF THE INVENTION

An electrical, conductive, flexible, aqueous polymer composition comprises an aqueous conductive polymer blend and an aqueous soluble peelable polymer blend. The peelable polymer blend comprises a water soluble polymer, an alkyl glycol, and a polyoxyalkene polymer. Upon mixture of the two blends and drying, synergistic results are obtained with regard to electrical conductivity, and improved flexibility, peelability, and processabilty, and good scratch resistance.

In general, the invention relates to a conductive, aqueous soluble polymeric composition comprising: an electrically conductive polymer blend comprising: from about 30% to about 90% by weight of a negative charge accepting polymer; from about 10% to about 70% by weight of a positive charge accepting polymer; and a peelable polymer blend comprising: from about 50% to about 90% by weight of water soluble polymer; from about 10% to about 50% by weight of an polyalkylene oxide; and from about 10 to about 40 parts by weight of an alkyl glycol for every 100 total parts by weight of said water soluble polymer and said polyalkylene oxide; and the amount of said conductive polymer blend comprising from about 55% to about 80% by weight and the amount of said peelable polymer blend comprising from about 20% to about 45% by weight of the total weight of the conductive, flexible polymer composition.

### DETAILED DESCRIPTION OF THE INVENTION

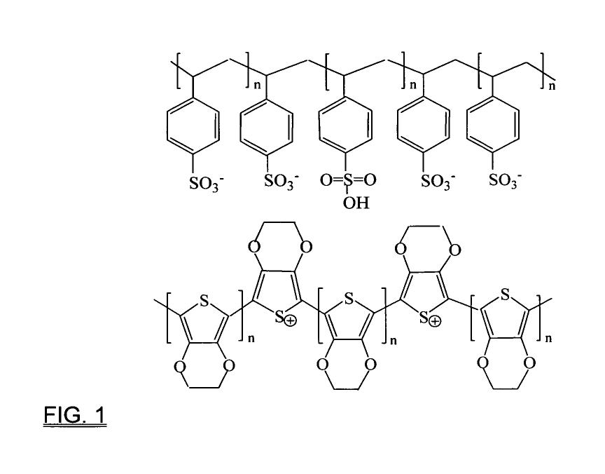

The conductive polymer blend contains at least one positive charge accepting polymer such as, but not limited to, poly(3,4-ethylenedioxythiopene) (PEDOT), Polythiophene (PT), Poly(3-alkylthiohen) (PA3T). The structure and synthesis of PEDOT and similar conductive polymers is disclosed in U.S. Pat. No. 5,035,926, which is hereby fully incorporated by reference. A representative chemical structure of PEDOT is set forth in FIG. 1. The PEDOT has a number average molecular weight of from about 600 to about 15,000 and preferably from about 750 to about 3,000 g/mol. The conductive polymer blend desirably also contains a negative charge accepting polymer such as poly(styrenesulfonate) (PSS), or any crosslinked polystyrene that is sulfonated. A representative chemical structure of PSS is set forth in FIG. 1. The number average molecular weight of the PSS is from about 1,200 to about 30,000 and preferably from about 1,500 to about 7,000 g/mol. The total amount of the one or more polythiopene or positive charge accepting polymers is generally from about 10% to about 70% and desirably from about 20% to about 40% by weight based upon the total weight of the positively and negatively charged polymers. Accordingly, the amount of the one or more negative charge accepting polymers is the difference, that is, generally from about 30% to about 90% and desirably from about 60% to about 80% by weight. A blend of the PEDOT and the PSS polymers is generally available as Clevios manufactured by the H.C. Starck Company, of Goslar, Germany. The conductive polymer blend is generally sold as an aqueous solution that contains from about 100 to about 5,000 desirably from about 500 to about 4,000 and preferably from about 1,000 to about 3,000 parts by weight of water for every 100 total parts by weight of the two or more polymers that form the conductive polymer blend.

The peelable polymer blend comprises at least three components, that is, a water soluble polymer such as poly(vinyl alcohol), poly(vinyl acetate) and various acrylates and methacrylates preferably derived from solution or emulsion latexes. The poly(vinyl alcohol) generally has a number average molecular weight of from about 50,000 to about 125,000 and desirably from about 75,000 to about 105,000 g/mol. Another important component of the peelable polymer blend is an alkyl glycol having from 2 to about 4 carbon atoms such as ethylene glycol, butylene glycol, and preferably propylene glycol. Another component is a polyalkylene oxide wherein the alkylene has from about 2 to about 4 or 5 carbon atoms with polyethylene oxide being preferred. The number molecular weight of the polyalkylene oxide is from about 300 to about 5,000, and desirably from about 400 to about 2,500 g/mol. If desired, the polymers can be crosslinked as with benzophenone-4.

The amount of the water soluble polymer is generally from about 50% to about 90%, desirably from about 55% to about 85%, and preferably from about 60% to about 80% by weight based upon the total weight of the water soluble polymer and the polyalkylene oxide polymer. Hence, the amount of the polyalkylene oxide is from about 10% to about 50%, desirably from about 15% to about 45%, and preferably from about 20% to about 40% by weight based upon the total weight of the polyalkylene oxide and the water soluble polymers. The amount of the alkylene glycol generally ranges from about 10 to about 40 parts by weight and desirably from about 15 to about 30 parts by weight for every 100 parts by weight of the one or more water soluble polymers and the one or more polyalkylene oxide or similar polymers. The amount of water in the peelable polymer blend generally ranges from about 100 to about 5,000, desirably from about 500 to about 3,000 and preferably from about 700 to about 1,500 parts by weight for every 100 total parts by weight of the total peelable polymers.

The overall weight amount of the conductive polymer blend is generally from about 55% to about 80%, desirably from about 60% to about 75%, and preferably from about 60% to about 70% by weight based upon the total weight of the conductive polymer blend and the peelable polymer blend. Hence, the amount by weight of the peelable polymer blend forming the conductive, flexible polymeric composition of the present invention is from about 20% to about 45%, desirably from about 25% to about 40%, and preferably from about 30% to about 40% by weight.

The flexible, aqueous soluble conductive polymer composition of the present invention is formed by mixing the electrically conductive polymer blend with the peelable polymer blend by any common method. For example, the two mixtures can be poured together and simply mixed with a stirrer, spoon, etc.

With regard to various end uses, it is desirable that the electrically conductive, flexible polymeric composition of the present invention is used as a film or layer. Preparation of the film occurs by mixing the conductive polymer blend with the peelable polymer blend as at room temperature e.g. from about 20° C. to about 30° C. or at temperatures of from about 15° C. to about 60° C., and then applying the mixture to a substrate, such as a flat substrate. Application can be any conventional manner known to the art and to the literature such as by casting, spraying, coating as with a doctor blade, spinning, and the like. Suitable flat substrates can include a variety of materials such as glass, metal such as aluminum, steel, etc., a silicon or siloxane substrate, wood, and the like. In order to form the film, the applied polymeric mixture on the substrate is heated to remove the water. Suitable heating temperatures are below the boiling point of water to avoid craters or pitting and generally range from about 30° C. to about 80° C. and preferably from about 50° C. to about 70° C. for a period of time to essentially remove all of the water and any other solvent present.

The invention will be better understood by reference to the following examples that serve to illustrate, but not to limit the scope thereof.

With respect to the peelable blend, 60 mg of Polyvinyl Alcohol (PVA 98000 MW), 20 mg of Propylene Glycol (PG) Polyalkylene oxide and 20mg of Polyethylene Glycol (PEG 400 MW) were dissolved in 1 g of water. Then 60 mg of PEDOT and 140 mg of PSS were dissolved in 1 g of water to obtain the conductive blend.

After both mixtures were made, 200 mg of the conductive blend (PEDOT/PSS) was mixed with 107 mg of the flexible blend (PVA/PG/PEG) to obtain a desired mixture of peelable and conductive polymer. Then 15 mg of the peelable and conductive polymer blend was placed on a spin casting setup that had a metallic drum of radius 7 cm and a height of 5 cm, and was spun at 12,000 RPM and heated to 80° C. for approximately 2 min, to obtain a film 10 μm thick, that was easily peeled from the drum. The resistivity of the film was 50 Ω/Sq. In contrast, a control of 60 mg of PEDOT and 140 mg of PSS dissolved in 1 g of water and added 52 mg of Dimethyl Sulfoxide (DMSO) solvent and conducting agent made in a similar manner having the same thickness had approximately the same resistivity. In other words, the resistivity of the conductive polymer-peelable polymer blend composition was only about 30% or less and desirably about 20% or about 10% or less greater than the Control of only the conductive polymer blend. Thus, the conductive, peelable polymeric composition blend had good electrical conductivity. This was unexpected since it was thought that the resistivity upon mixing the peelable polymer with the conductive polymer blend and drying the solution composition would actually be increased much greater than 20% or 30%. The conductive, flexible polymeric blend is very flexible and is capable of being flexed to 180° and is readily unfolded back to a flat layer. The coating is readily peelable and removable from the substrate and can be applied to another polymer or substrate and stuck thereto. The coating also has good scratch resistance and when rubbed in a single direction imparts a planar alignment with respect to any nematic liquid crystals contained within an adjacent (below) layer. The material also has good mechanical strength and anti-static properties.

The film can be as thin as a monolayer (on the order of nanometers (depending on the casting techniques used) and as thick as desired. Generally thicker films take a longer time to dry.

An advantage of the present invention is that the conductive, peelable film can be prepared on a stand alone substrate whereas heretofore, films were generally prepared on a substrate that provided mechanical support.

Another advantage is that when the present invention is used in flexible displays utilizing ω-flex as electrodes in a simple planar liquid crystal cell, the electrodes have the capability to act as a surface alignment layer that is achieved by rubbing the conductive-peelable polymer blend coating in a specific direction. The result is that the liquid crystals are aligned in the same direction as the rubbing. In other words, it has been found that the liquid crystals or other molecules, for example another polymer layer such as polyimide, or polyvinyl acetate, can be aligned to provide a predetermined or planar surface alignment.

The conductive, flexible polymer composition films of the present invention can be used in a vast number of applications such as anti-static coatings of glass and polymers, as a substrate in electronic equipment for connecting one electrically conductive member to another electrically conductive member, for use in organic and polymeric light emitting diodes for smothering an anode surface, for printed wireless boards, as a conductive coating and generally any electronic application, for use with organic transistors as a drain, gate electrode or source, for use with liquid crystal cells as in a laminate or sandwich cell wherein two parallel conductive, flexible polymer composition layers are separated by any phase (nematic, cholesteric, smectic, blue phase, or columnar) liquid crystal film that could be used in flexible displays, electromechanically transducers and the like.

An advantage of the present invention is that, inasmuch as the conductive polymer blend as well as the peelable polymer blend are water soluble, once the conductive polymer composition has been utilized as with regard to liquid crystals, it can be recycled simply by adding water to the film or coating and dissolving the same.

While in accordance with the patent statutes the best mode and preferred embodiment have been set forth, the scope of the invention is not intended to be limited thereto, but only by the scope of the attached claims.

What is claimed is:

1. A conductive, aqueous soluble polymeric composition comprising:
an electrically conductive polymer blend comprising:
a. from about 30% to about 90% by weight of a negative charge accepting polymer;
b. from about 10% to about 70% by weight of a positive charge accepting polymer; and
a peelable polymer blend comprising:
a. from about 50% to about 90% by weight of water soluble polymer;
b. from about 10% to about 50% by weight of an polyalkylene oxide; and
c. from about 10 to about 40 parts by weight of an alkyl glycol for every 100 total parts by weight of said water soluble polymer and said polyalkylene oxide; and
the amount of said conductive polymer blend comprising from about 55% to about 80% by weight and the amount of said peelable polymer blend comprising from about 20% to about 45% by weight of the total weight of the conductive, flexible polymer composition.

2. The conductive, aqueous soluble polymer composition of claim 1, wherein the total amount of water is from about 100 to about 5,000 parts by weight per 100 parts by weight of said electrically conductive polymer blend; and
wherein the total amount of water is from about 100 to about 5,000 parts by weight per 100 parts by weight of said peelable polymer blend.

3. The conductive, aqueous soluble polymer composition of claim 2, wherein the amount of said conductive polymer blend is from about 60% to about 75% by weight and wherein the amount of said peelable polymer blend is from about 25% to about 40% by weight.

4. The conductive, aqueous soluble polymer composition of claim 3, wherein the amount of said negative-charged accepting polymer is from about 60% to about 80% by weight and wherein the amount of said positive-charged accepting polymer is from about 20% to about 40% by weight;
wherein the total amount of said water soluble polymer is from about 55% to about 85% by weight, wherein the total amount of said polyalkylene oxide polymer is from about 15% to about 45% by weight, and wherein the total amount of said alkyl glycol is from about 15 to about 30 parts by weight per 100 parts by weight of said water soluble polymer and said polyalkylene oxide polymer.

5. The conductive, aqueous soluble polymer composition of claim 4, wherein the total amount of water is from about 1,000 to about 3,000 parts by weight per 100 total parts by weight of said electrically conductive polymer blend;
wherein the total amount of water is from about 700 to about 1,500 parts by weight per 100 total parts by weight of said peelable polymer blend; and
wherein the amount by weight of said conductive polymer blend is from about 60% to about 70% by weight and wherein the amount of said peelable polymer blend is from about 30% to about 40% by weight.

6. The conductive, aqueous soluble polymer composition of claim 1, wherein said positive-charged accepting polymer comprises poly(3,4-ethylenedioxythiopene) (PEDOT), Polythiophene (PT), Poly(3-alkylthiohen) (PA3T), or a conjugated polymer, or any combination thereof, and wherein said negative-charged accepting polymer comprises poly(styrenesulfonate) (PSS), or a sulfonated crosslinked polystyrene, or any combination thereof.

7. The conductive, aqueous soluble polymer composition of claim 4, wherein said positive-charged accepting polymer comprises poly(3,4-ethylenedioxythiopene) (PEDOT), Polythiophene (PT), Poly(3-alkylthiohen) (PA3T), or a conjugated polymer, or any combination thereof, and wherein said negative-charged accepting polymer comprises poly(styrenesulfonate) (PSS), or a sulfonated crosslinked polystyrene, or any combination thereof.

8. The conductive, aqueous soluble polymer composition of claim 3, wherein said positive-charged accepting polymer comprises poly(3,4-ethylenedioxythiopene) (PEDOT), Polythiophene (PT), Poly(3-alkylthiohen) (PA3T), or a conjugated polymer, or any combination thereof, and wherein said negative-charged accepting polymer comprises poly(styrenesulfonate) (PSS), or a sulfonated crosslinked polystyrene, or any combination thereof; wherein said water soluble polymer comprises poly(vinyl alcohol), wherein said alkylene of said polyalkylene oxide, independently, has from 2 to about 5 carbon atoms, and wherein said alkyl of said alkyl glycol has from 2 to about 4 carbon atoms.

9. The conductive, aqueous soluble polymer composition of claim 8, wherein said positive-charged accepting polymer is PEDOT, wherein said negative-charged accepting polymer is PSS, wherein said water soluble polymer is poly(vinyl alcohol), wherein said polyalkylene oxide is polyethylene oxide, and wherein said alkyl glycol is propylene glycol.

10. A process for forming a conductive, aqueous soluble polymer composition comprising the steps of:
forming an electrically-conductive polymer blend comprising from about 30% to about 90% by weight of a negative charge accepting polymer, and from about 10% to about 70% by weight of a positive charge accepting polymer;
forming a peelable polymer blend comprising from about 50% to about 90% by weight of water soluble polymer, from about 10% to about 50% by weight of an polyalkylene oxide, and from about 10 to about 40 parts by weight of an alkyl glycol for every 100 total parts by weight of said water soluble polymer and said polyalkylene oxide; and
blending said electrically-conductive polymer blend with said peelablepolymer conductive blend.

11. The process of claim 10, wherein the total amount of water is from about 100 to about 5,000 parts by weight per 100 parts by weight of said electrically conductive polymer blend;
wherein the total amount of water is from about 100 to about 5,000 parts by weight per 100 parts by weight of said peelable polymer blend; and
wherein the amount of said conductive polymer blend is from about 60% to about 75% by weight and wherein the amount of said peelable polymer blend is from about 25% to about 40% by weight.

12. The process of claim 11, wherein the amount of said negative-charged accepting polymer is from about 60% to about 80% by weight and wherein the amount of said positive-charged accepting polymer is from about 20% to about 40% by weight;
wherein the total amount of said water soluble polymer is from about 55% to about 85% by weight, wherein the total amount of said polyalkylene oxide polymer is from about 15% to about 45% by weight, and wherein the total amount of said alkyl glycol is from about 15 to about 30 parts by weight per 100 parts by weight of said water soluble polymer and said polyalkylene oxide polymer.

13. The process of claim 10, wherein said positive-charged accepting polymer comprises poly(3,4-ethylenedioxythiopene) (PEDOT), Polythiophene (PT), Poly(3-alkylthiohen) (PA3T), or a conjugated polymer, or any combination thereof, and wherein said negative-charged accepting polymer comprises poly(styrenesulfonate) (PSS), or a sulfonated crosslinked polystyrene, or any combination thereof.

14. The process of claim 12, wherein said positive-charged accepting polymer comprises poly(3,4-ethylenedioxythiopene) (PEDOT), Polythiophene (PT), Poly(3-alkylthiohen) (PA3T), or a conjugated polymer, or any combination thereof, and wherein said negative-charged accepting polymer comprises poly(styrenesulfonate) (PSS), or a sulfonated crosslinked polystyrene, or any combination thereof.

15. The process of claim 12, wherein said positive-charged accepting polymer comprises poly(3,4-ethylenedioxythiopene) (PEDOT), Polythiophene (PT), Poly(3-alkylthiohen) (PA3T), or a conjugated polymer, or any combination thereof, and wherein said negative-charged accepting polymer comprises poly(styrenesulfonate) (PSS), or a sulfonated crosslinked polystyrene, or any combination thereof; wherein said water soluble polymer comprises poly(vinyl alcohol), wherein said alkylene of said polyalkylene oxide, independently, has from 2 to about 5 carbon atoms, and wherein said alkyl of said alkyl glycol has from 2 to about 4 carbon atoms.

16. The dried conductive polymer composition of claim 10, wherein said dried composition has a resistivity less than about 30% greater than a dried composition prepared from only said conductive polymer blend.

17. The dried conductive polymer composition of claim 12, wherein said dried composition has a resistivity less than about 20% greater than a dried composition prepared from only said conductive polymer blend.

18. The dried conductive polymer composition of claim 15, wherein said dried composition has a a resistivity less than about 20% greater than a dried composition prepared from only said conductive polymer blend.

19. The dried conductive polymer composition of claim 10, wherein rubbing said dried conductive-peelable layer in a specific direction imparts substantially the same alignment to a liquid crystal layer located therebelow.

20. The dried conductive polymer composition of claim 14, wherein rubbing said dried conductive-peelable layer in a specific direction imparts substantially the same alignment to a liquid crystal layer located therebelow.
